(19) United States
(12) Patent Application Publication
(10) Pub. No.: US 2025/0210810 A1
(43) Pub. Date: Jun. 26, 2025

(54) ALL-SOLID-STATE SECONDARY BATTERY AND METHOD FOR MANUFACTURING ALL-SOLID-STATE SECONDARY BATTERY

(71) Applicant: Samsung SDI Co., Ltd., Yongin-si, Gyeonggi-do (KR)

(72) Inventors: Ikhwan Cho, Yongin-si (KR); Jinhwan Park, Yongin-si (KR); Byeongdo Kwak, Yongin-si (KR)

(21) Appl. No.: 18/849,423

(22) PCT Filed: Feb. 23, 2023
(86) PCT No.: PCT/KR2023/002616

§ 371 Date: Sep. 20, 2024

(30) Foreign Application Priority Data
Mar. 23, 2022 (KR) 10-2022-0036124

(51) Int. Cl. H01M 50/474; H01M 10/04; H01M 10/0585; H01M 50/403; H01M 50/477; H01M 50/486

(52) U.S. Cl. CPC H01M 50/474; H01M 10/049; H01M 10/0585; H01M 50/403; H01M 50/477; H01M 50/486

(57) ABSTRACT

Provided are an all-solid-state secondary battery and a method of manufacturing the all-solid-state secondary battery. According to an aspect of the present disclosure, there is provided a method of manufacturing an all-solid-state secondary battery, the method including forming a unit stack cell structure including a cathode layer, a solid electrolyte layer, an anode layer, and an elastic layer, inserting the unit stack cell structure into a housing, and foaming the elastic layer, wherein, in the forming of the unit stack cell structure, the elastic layer has a pad shape that is not foamed, and in the foaming of the elastic layer, the elastic layer is in the form of a foam.

### TECHNICAL FIELD

The present disclosure relates to an all-solid-state secondary battery and a method of manufacturing the all-solid state secondary battery, and more particularly, to an all-solid-state secondary battery including an elastic sheet and a manufacturing method thereof.

### BACKGROUND ART

Recently, batteries with high energy density and safety have been actively developed in response to industrial demand. For example, lithium-ion batteries are being put into practice in the field of automobiles, as well as in the field of information-related equipment and communications equipment. Meanwhile, the safety of lithium-ion batteries is important because the automotive field may be directly related to the lives of passengers.

Since currently available lithium-ion batteries employ an electrolyte containing a flammable organic solvent, overheating and fires are possible when a short circuit occurs. Accordingly, an all-solid-state battery using a solid electrolyte instead of a liquid electrolyte has been proposed. Since the all-solid-state secondary battery does not use a flammable organic solvent, the possibility of fire or explosion may be greatly reduced even in the occurrence of a short circuit, and safety may be greatly increased compared to a lithium-ion battery using an electrolyte.

However, when a laminate of the all-solid-state batteries is put into an exterior body, or compressed using a laminate film after lamination, or pressure is applied on the all-solid-state battery, stress is transferred to the solid electrolyte and this stress may cause damage or short circuit of the solid electrolyte along with a stress occurring during future charging and discharging.

Particularly, during discharging, when the all-solid-state battery is not uniformly pressurized from the outside, lithium ions move to the locally pressurized part, hence lowering discharge efficiency. Such non-uniform pressurization may cause damage to the solid electrolyte.

### DISCLOSURE

### Technical Problem

The present disclosure provides an all-solid-state secondary battery with a high stress relief elastic layer that disperses stress applied to a solid electrolyte to enable uniform pressurization, uniformly pressurizes, with an excellent restoring force, a contact surface between an anode and the solid electrolyte when discharging, to enhance discharging efficiency, and reduces stress transfer to the solid electrolyte even if the thickness of the anode is increased by dendrite generated at the anode in a charging environment.

### Technical Solution

In the present disclosure, the problem is solved by applying an elastic sheet including a foam component in an all-solid-state battery laminating operation, and applying a post-foam elastic layer that foams the elastic sheet after laminating.

According to an aspect of the present disclosure, there is provided a method of manufacturing an all-solid-state secondary battery, the method including forming a unit stack cell structure including a cathode layer, a solid electrolyte layer, an anode layer, and an elastic layer, inserting the unit stack cell structure into a housing, and foaming the elastic layer, wherein, in the forming of the unit stack cell structure, the elastic layer has a pad shape that is not foamed, and in the foaming of the elastic layer, the elastic layer is in the form of a foam.

In the method of manufacturing an all-solid-state secondary battery according to an embodiment of the present disclosure, the method further includes, before forming the unit stack cell structure, forming the elastic layer, wherein, in the forming of the elastic layer, a foaming agent and reinforcing particles may be mixed with syrup including an acrylate monomer.

In the method of manufacturing an all-solid-state secondary battery according to an embodiment of the present disclosure, the forming of the elastic layer includes preparing a syrup by bulk polymerization of acrylate monomers including hydroxy groups as acrylate monomers and acrylate monomers including alkyl groups by using heat or ultraviolet (UV), mixing the syrup with acrylic monomers, silica, 2 to 6 functional acrylate, foaming agents, photoinitiators or thermal initiators, and the reinforcing particles to prepare a mixture, and coating a polyethylene terephthalate (PET) release film with the mixture, followed by curing the same with UV.

In the method of manufacturing an all-solid-state secondary battery according to an embodiment of the present disclosure, the reinforcing particles may include an elastic material and may include elastic particles with a diameter of 1,000 nm or less.

In the method of manufacturing an all-solid-state secondary battery according to an embodiment of the present disclosure, the elastic material may include at least one selected from the group consisting of polyurethane, natural rubber, spandex, isobutylene isoprene rubber (IIR), fluoroelastomer, elastomer, ethylene-propylene rubber (EPR), styrene-butadiene rubber (SBR), chloroprene, elastin, rubber epichlorohydrin, nylon, terpene, isoprene rubber, polybutadiene rubber, nitrile rubber, thermoplastic elastomer, silicone rubber, ethylene-propylene-diene monomer (EPDM) rubber, ethylene vinyl acetate (EVA), halogenated butyl rubber, neoprene, and a copolymer thereof.

In the method of manufacturing an all-solid-state secondary battery according to an embodiment of the present disclosure, the reinforcing particles may include hollow particles including at least one of nanoparticles having a core-shell structure, nanosilica, hollow nanoparticles, and hollow microparticles.

In the method of manufacturing an all-solid-state secondary battery according to an embodiment of the present disclosure, the foaming of the elastic layer may include heating the elastic layer at 120° C. to 140° C.

In the method of manufacturing an all-solid-state secondary battery according to an embodiment of the present disclosure, the elastic layer may have a thickness of 100 μm to 800 μm before foaming, and the thickness after foaming may be 1.1 to 2 times the thickness before foaming.

In the method of manufacturing an all-solid-state secondary battery according to an embodiment of the present disclosure, the forming of the unit stack cell structure may include sequentially laminating the anode layer, the solid electrolyte layer, and the cathode layer in that order on each of one side and the other side of the elastic layer, so as to face each other around the elastic layer.

In the method of manufacturing an all-solid-state secondary battery according to an embodiment of the present disclosure, the forming of the unit stack cell structure may be performed by repeatedly stacking the cathode layer, the solid electrolyte layer, the anode layer, and the elastic layer in that order.

According to another aspect of the present disclosure, there is provided an all-solid-state secondary battery including a housing, and a unit stack cell structure arranged in the housing and including a cathode layer, a solid electrolyte layer, an anode layer, and an elastic layer, wherein the elastic layer is in the form of a pad that is not foamed, and is foamed after being inserted into the housing to have a foam shape.

In the all-solid-state secondary battery according to an embodiment of the present disclosure, the elastic layer may include an elastic material and may include elastic particles with a diameter of 1,000 nm or less.

In the all-solid-state secondary battery according to an embodiment of the present disclosure, the elastic material may include at least one selected from the group consisting of polyurethane, natural rubber, spandex, isobutylene isoprene rubber (IIR), fluoroelastomer, elastomer, ethylene-propylene rubber (EPR), styrene-butadiene rubber (SBR), chloroprene, elastin, rubber epichlorohydrin, nylon, terpene, isoprene rubber, polybutadiene rubber, nitrile rubber, thermoplastic elastomer, silicone rubber, ethylene-propylene-diene monomer (EPDM) rubber, ethylene vinyl acetate (EVA), halogenated butyl rubber, neoprene, and a copolymer thereof.

In the all-solid-state secondary battery according to an embodiment of the present disclosure, the elastic layer may include hollow particles including at least one of nanoparticles having a core-shell structure, nanosilica, hollow nanoparticles, and hollow microparticles.

In the all-solid-state secondary battery according to an embodiment of the present disclosure, the elastic layer may have a thickness of 100 μm to 800 μm before foaming, and the thickness after foaming may be 1.1 to 2 times the thickness before foaming.

In the all-solid-state secondary battery according to an embodiment of the present disclosure, the unit stack cell structure may be formed by sequentially laminating the anode layer, the solid electrolyte layer, and the cathode layer in that order on each of one side and the other side of the elastic layer, so as to face each other around the elastic layer.

In the all-solid-state secondary battery according to an embodiment of the present disclosure, the unit stack cell structure may be formed by repeatedly stacking the cathode layer, the solid electrolyte layer, the anode layer, and the elastic layer in that order.

### Advantageous Effects

The all-solid-state secondary battery and the method of manufacturing the all-solid-state secondary battery according to an embodiment of the present disclosure may increase discharge efficiency by dispersing stress applied to a solid electrolyte and reduce stress transfer applied to the solid electrolyte during charging.

The all-solid-state secondary battery and the method of manufacturing the all-solid-state secondary battery according to an embodiment of the present disclosure use an elastic layer in an unfoamed state, so that a unit stack cell structure may be easily inserted into a housing and then foamed.

### DESCRIPTION OF DRAWINGS

FIG. 1 shows an all-solid-state secondary battery according to an embodiment of the present disclosure.

FIG. 2 shows an all-solid-state secondary battery according to another embodiment of the present disclosure.

FIGS. 3 to 6 show a method of manufacturing a solid state secondary battery according to an embodiment of the present disclosure.

### BEST MODE

According to an aspect of the present disclosure, there is provided a method of manufacturing an all-solid-state secondary battery, the method including forming a unit stack cell structure including a cathode layer, a solid electrolyte layer, an anode layer, and an elastic layer, inserting the unit stack cell structure into a housing, and foaming the elastic layer, wherein, in the forming of the unit stack cell structure, the elastic layer has a pad shape that is not foamed, and in the foaming of the elastic layer, the elastic layer is in the form of a foam.

### MODE FOR INVENTION

The present inventive concept described below may apply various transforms and may have various embodiments, and specific embodiments are illustrated in the drawings and described in the detailed description in detail. However, this is not intended to limit the inventive concept to a specific embodiment, and it should be understood that the present inventive concept includes all transforms, equivalents, or replacements included in the technical scope of the inventive concept.

The terms used hereinafter are used only to describe particular embodiments, and are not intended to limit the present inventive concepts. The expression of the singular includes the expression of the plural, unless the context clearly indicates otherwise. It will be further understood that the terms “comprise” or “have” used herein, specify the presence of stated features, numbers, steps, operations, elements, components, ingredients, materials, or combinations thereof, but do not preclude the presence or addition of one or more other features, numbers, steps, operations, elements, components, ingredients, materials, or combinations thereof. The symbol “/” used below may be interpreted as “and” depending on the situation or may be interpreted as “or”.

In the drawings, the thickness is enlarged or reduced in order to clearly express various layers and regions. Like parts are denoted by the same reference numerals throughout the specification. It will be further understood that when a layer, a film, an area, a plate, or the like is referred to as being “on” or “over” another part throughout the specification, it is not only a case located directly on the other but also a case in which there is another part in the middle. Through the whole disclosure, the terms first, second, etc. may be used to describe various components, but the components should not be limited by terms. Terms are used only for the purpose of distinguishing one component from another.

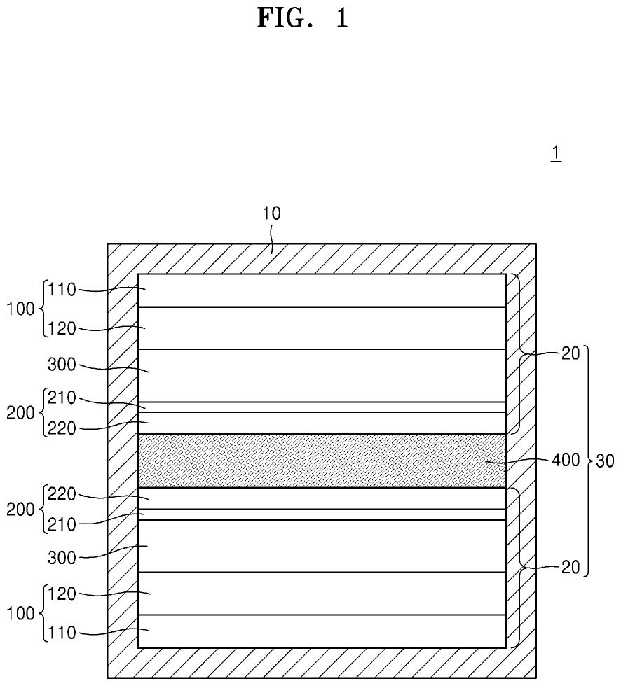

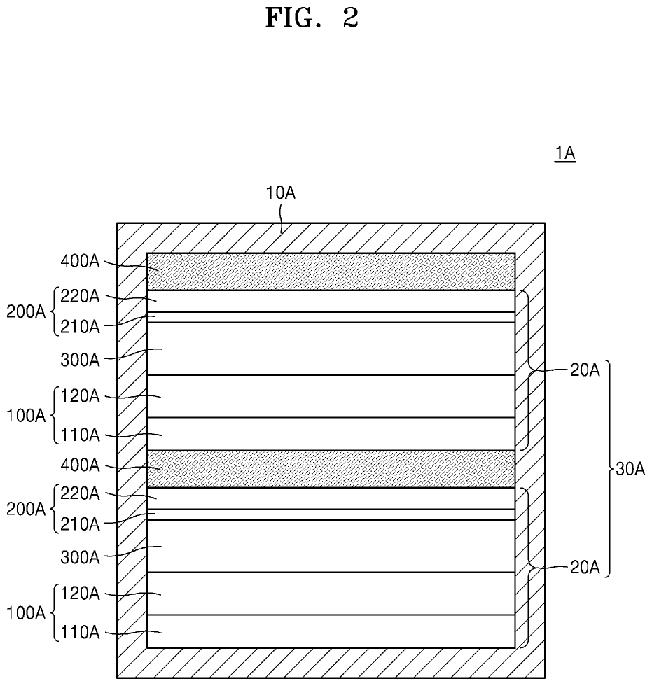

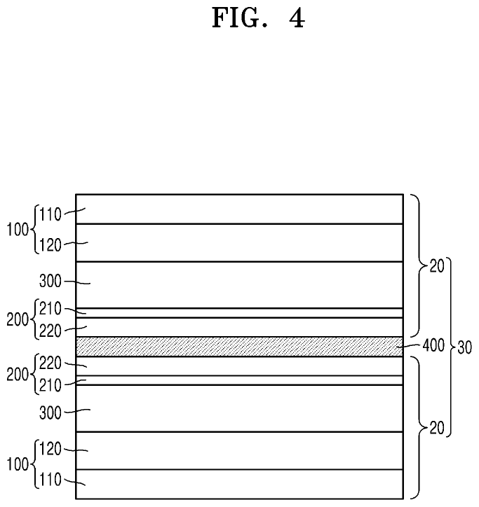

FIG. 1 shows an all-solid-state secondary battery 1 in accordance with an embodiment of the present disclosure, and FIGS. 2 to 6 show a method of manufacturing an all-solid-state secondary battery 1 in accordance with an embodiment of the present disclosure.

Referring to FIG. 1, an all-solid-state secondary battery 1 according to an embodiment of the present disclosure may include a housing 10 and a unit stack cell structure 30 including one or more unit cells 20. More specifically, FIG. 1 shows a state in which an elastic layer 400, which will be described later, is foamed after the unit stack cell structure 30 is arranged in the housing 10.

The housing 10 includes an inner space into which the unit stack cell structure 30 is inserted. The housing 10 may have a can type or a pouch type, and may be sealed after the unit stack cell structure 30 is inserted therein.

One or more unit cells 20 may form the unit stack cell structure 30, and may be arranged in the housing 10. The unit cell 20 may include a cathode layer 100, an anode layer 200, and a solid electrolyte layer 300. For example, in the unit cell 20, the cathode layer 100, the solid electrolyte layer 300, and the anode layer 200 may be laminated in the stated order as shown in FIG. 1. In addition, as shown in FIG. 1, the unit stack cell structure 30 may include two unit cells 20, which may be arranged to be symmetrical with the elastic layer 400 therebetween. That is, the anode layer 200, the solid electrolyte layer 300, and the cathode layer 100 may be sequentially arranged below the elastic layer 400. In addition, the anode layer 200, the solid electrolyte layer 300, and the cathode layer 100 may be sequentially arranged above the elastic layer 400. More specifically, as shown in FIG. 1, in the unit stack cell structure 30, a cathode current collector 110, a cathode active material layer 120, a solid electrolyte layer 300, an anode current collector 210, and an anode active material layer 220 may be sequentially arranged from bottom to top, an elastic layer 400 may be arranged on the anode active material layer 220, and another anode active material layer 220, another anode current collector 210, another solid electrolyte layer 300, another cathode active material layer 120, and another cathode current collector 110 may be sequentially arranged above the elastic layer 400. In addition, the cathode current collectors 110 respectively placed on an upper portion and a lower portion of the unit stack cell structure 30 may contact the upper and lower portions of the housing 10, respectively.

Although FIG. 1 shows that two unit cells 20 form one unit stack cell structure 30, embodiments are not limited thereto. There may be one or three or more unit cells 20. In addition, FIG. 1 shows that the elastic layer 400 is arranged only between the unit cells 20, but embodiments are not limited thereto. The respective elastic layers 400 may be additionally arranged on the lower and upper portions of the unit cell 20, that is, between each of the unit cells 20 and the housing 10.

As described above, since the elastic layer 400 is arranged on the anode layer 200, Coulombic efficiency of the solid state secondary battery 1 may be increased. That is, even if the thickness of the anode active material layer 220 changes due to charging and discharging of the unit cell 20, the followability with respect to the anode current collector 210 is improved due to the elastic layer 400, deterioration of the contact state between the solid electrolyte layer 300 and the anode current collector 210 may be suppressed, thereby providing the all-solid-state secondary battery 1 with high Coulombic efficiency. In addition, since the elastic layer 400 is arranged on the opposite side of the solid electrolyte layer 300 based on the anode current collector 210, the elastic layer 400 is prevented from reacting with lithium of the anode layer 200 and deteriorating. In this respect, Coulombic efficiency may also be increased. In this way, the unit stack cell structure 30 may suppress the volume change of the all-solid-state secondary battery 1 by including the elastic layer 400 that may absorb the volume change of the cathode layer 200. Through this, the all-solid-state secondary battery 1 may obtain stable life characteristics.

The cathode layer 100 may include a cathode current collector 110 and a cathode active material layer 120 arranged on the cathode current collector 110. In addition, the anode layer 200 may include an anode current collector 210 and an anode active material layer 220 arranged on the anode current collector 210.

In an embodiment, the cathode current collector 110 employs at least one of a plate and a foil, made of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. In another embodiment, the cathode current collector 110 may be omitted.

The cathode active material layer 120 may include, for example, a cathode active material and a solid electrolyte. The solid electrolyte included in the cathode active material layer 120 may be similar to or different from the solid electrolyte included in the solid electrolyte layer 300.

The cathode active material may reversibly absorb and desorb lithium ions. The cathode active material may include, for example, a lithium transition metal oxide such as a lithium cobalt oxide (LCO), a lithium nickel oxide, a lithium nickel cobalt oxide, a lithium nickel cobalt aluminum oxide (NCA), a lithium nickel cobalt manganese oxide (NCM), a lithium manganese oxide, a lithium iron phosphate, or the like, a nickel sulfide, a copper sulfide, a lithium sulfide, an iron oxide, a vanadium oxide, or the like, but is not necessarily limited thereto, and any material available in the art as a cathode active material may be used. The cathode active materials may be used alone or as a mixture of two or more components.

In an embodiment, the lithium transition metal oxide is a compound represented by any one of the chemical formulas: LiₐA_{1-b}B_{b}D₂ (where 0.90≤a≤1 and 0≤b≤0.5); LiₐE_{1-b}B_{b}O_{2-c}D_{c} (where 0.90≤a≤1, 0≤b≤0.5, and 0≤c≤0.05); LiE_{2-b}B_{b}O_{4-c}D_{c} (where 0≤b≤0.5 and 0≤c≤0.05); LiₐNi_{1-b-c}CO_{b}B_{c}D_{α} (where 0.90≤a≤1, 0≤b≤0.5, 0≤c≤0.05, and 0<a≤2); LiₐNi_{1-b-c}Co_{b}O_{2-α}F_{α} (where 0.90≤a≤1, 0≤b≤0.5, 0≤c≤0.05, and 0<α≤2); LiₐNi_{1-b-c}Co_{b}B_{c}O_{2-α}F₂ (where 0.90≤a≤1, 0≤b≤0.5, 0≤c≤0.05, and 0<α<2); LiₐNi_{1-b-c}Mn_{b}B_{c}D_{α} (where 0.90≤a≤1, 0≤b≤0.5, 0≤c≤0.05, and 0<α≤2); LiₐNi_{1-b-c}Mn_{b}B_{c}O_{2-α}F_{α} (where 0.90≤a≤1, 0≤b≤0.5, 0≤c≤0.05, and 0<α<2); LiₐNi_{1-b-c}Mn_{b}B_{c}O_{2-α}F₂ (where 0.90≤a≤1, 0≤b≤0.5, 0≤c≤0.05, and 0<α<2); LiₐNi_{b}E_{c}G_{d}O₂ (where 0.90≤a≤1, 0≤b≤0.9, 0<c≤0.5, and 0.001≤d≤0.1); LiₐNi_{b}Co_{c}Mn_{d}GₑO₂ (where 0.90≤a≤1, 0≤b≤0.9, 0≤c≤0.5, 0≤d≤0.5, and 0.001≤e≤0.1); LiₐNiG_{b}O₂ (where 0.90≤a≤1 and 0.001≤b≤0.1); LiₐCoG_{b}O₂ (where 0.90≤a≤1 and 0.001≤b≤0.1); LiₐMnG_{b}O₂ (where 0.90≤a≤1 and 0.001≤b≤0.1); LiₐMn₂G_{b}O₄ (where 0.90≤a≤1 and 0.001≤b≤0.1); QO₂; QS₂; LiQS₂; V₂O₅; LiV₂O₅; LiIO₂; LiNiVO₄; Li_{(3-f)}J₂(PO₄)₃ (0≤f≤2); Li_{(3-f)}Fe₂(PO₄)₃ (0≤f≤2); and LiFePO₄. In these compounds: A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof. A compound in which a coating layer is added on the surface of such a compound may be used, or a mixture of the compound with a compound in which the coating layer is added may be used. The coating layer added to the surface of such a compound includes, for example, a coating element compound of an oxide or hydroxide of a coating element, oxyhydroxide of the coating element, oxycarbonate of the coating element, or hydroxycarbonate of the coating element. The compound constituting such a coating layer is amorphous or crystalline. Coating elements included in the coating layer are Mg, Al, Co, K, Na, Ca, Si, Ti, V, Sn, Ge, Ga, B, As, Zr, or a mixture thereof. A method of forming the coating layer is selected within a range that does not adversely affect the physical properties of the cathode active material. Coating methods include, for example, spray coating, dipping method, etc. Since a specific coating method may be easily understood by a person skilled in the art, a detailed description thereof will be omitted.

In an embodiment, the cathode active material may include lithium salt of a transition metal oxide having a layered rock salt type structure among the lithium metal oxides described above. The layered rock salt type structure is a structure in which an oxygen atomic layer and a metal atomic layer are alternately and regularly arranged in a <111> direction of, for example, a cubic rock salt type structure, whereby each atomic layer forms a two-dimensional plane. The cubic rock salt type structure represents a sodium chloride (NaCl) type structure, which is a kind of crystal structure, and specifically, has a structure in which face centered cubic lattices (FCC), which are respectively formed by cations and anions, is arranged to be misaligned by ½ of a ridge of a unit lattice. The lithium transition metal oxide having such a layered rock salt type structure is, for example, a ternary lithium transition metal oxide, such as, for example, LiNiₓCo_{y}Al_{z}O₂ (NCA) or LiNiₓCo_{y}Mn_{z}O₂ (NCM) (0<x<1, 0<y<1, 0<z<1, and x+y+z=1). When the cathode active material includes a ternary lithium transition metal oxide having a layered rock salt type structure, the energy density and thermal stability of the all-solid-state secondary battery 1 are further improved.

The cathode active material may be covered with a coating layer. Any coating layer that is known as the coating layer of the cathode active material of the all-solid-state secondary battery may be used. For example, the coating layer may include Li₂O—ZrO₂ (LZO) or the like.

In an embodiment, when the cathode active material includes nickel (Ni) as a ternary lithium transition metal oxide such as NCA or NCM, the capacity density of the all-solid-state secondary battery 1 may be increased to reduce the dissolution of metal of the cathode active material in a charged state. As a result, the cycle characteristics of the all-solid-state secondary battery 1 in a charged state are improved.

In an embodiment, the cathode active material may have a particle shape such as a genuine spherical shape or an elliptical spherical shape. The particle diameters of the cathode active material are not particularly limited and is within a range applicable to a cathode active material of a conventional all-solid-state secondary battery. The content of the cathode active material of the cathode layer 100 is not particularly limited, and is within a range applicable to a cathode of a conventional all-solid-state secondary battery.

In an embodiment, the solid electrolyte included in the cathode active material layer 120 may have a smaller average particle diameter (D50) than the solid electrolyte included in the solid electrolyte layer 300. For example, the D50 of the solid electrolyte included in the cathode active material layer 120 may be 90% or less, 80% or less, 70% or less, 60% or less, 50% or less, 40% or less, 30% or less, or 20% or less of the D50 of the solid electrolyte included in the solid electrolyte layer 300.

In an embodiment, the cathode active material layer 120 may include a binder. The binder may be, for example, styrene butadiene rubber (SBR), polytetrafluoroethylene, polyvinylidene fluoride, polyethylene, or the like.

In an embodiment, the cathode active material layer 120 may include a conductive material. The conductive material may be, for example, graphite, carbon black, acetylene black, Ketjen black, carbon fiber, or metal powder.

In an embodiment, the cathode layer 100 may further include an additive such as, for example, a filler, a coating agent, a dispersant, and an ion conductive auxiliary agent, in addition to a cathode active material, a solid electrolyte, a binder, and a conductive material. As a filler, a coating agent, a dispersant, an ion conductive auxiliary agent, and the like that may be included in the cathode layer 100, a known material generally used in an electrode of an all-solid-state secondary battery may be used.

The anode layer 200 may include an anode current collector 210 and an anode active material layer 220.

The anode current collector 210 includes, for example, a material that does not react with lithium, that is, does not form both an alloy and a compound. Materials constituting the anode current collector 210 include, for example, copper (Cu), stainless steel, titanium (Ti), iron (Fe), cobalt (Co), nickel (Ni), and the like, but are not necessarily limited thereto. Anything that may be used as an electrode current collector in the relevant technical field is possible. In an embodiment, the thickness of the anode current collector 210 is 1 μm to 20 μm, 5 μm to 15 μm, for example, 7 μm to 10 μm.

The anode active material layer 220 may include, for example, an anode active material and a binder. The anode active material may have a particle form. The average particle diameter of the anode active material in a particle form may be 4 μm or less, 3 μm or less, 2 μm or less, 1 μm or less, or 900 nm or less. Alternatively, the average particle diameter of the anode active material may be, for example, 10 nm to 4 μm, 10 nm to 3 μm, 10 nm to 2 μm, 10 nm to 1 μm, or 10 nm to 900 nm. Since the anode active material has an average particle diameter in this range, reversible absorbing and/or desorbing of lithium during charging and discharging may be easier. The average particle diameter of the anode active material may be a median diameter (D50) measured using a laser particle size distribution meter.

The anode active material included in the anode active material layer 220 may include at least one selected from carbon-based anode active materials and metal or metalloid anode active materials.

The carbon-based anode active material is particularly amorphous carbon. The amorphous carbon may be, for example, carbon black (CB), acetylene black (AB), furnace black (FB), Ketjen black (KB), graphene, or the like, but is not limited thereto, and all that may be classified as amorphous carbon in the art are possible. Amorphous carbon is carbon that does not have crystallinity or has very low crystallinity and is distinguished from crystalline carbon or graphite-based carbon.

The metal or metalloid anode active material may include at least one selected from the group consisting of gold (Au), platinum (Pt), palladium (Pd), silicon (Si), silver (Ag), aluminum (Al), bismuth (Bi), tin (Sn), and zinc (Zn), but is not limited thereto, and any metal anode active material or metalloid anode active material forming an alloy or compound with lithium in the art may be used. For example, nickel (Ni) is not a metal anode active material because nickel (Ni) does not form an alloy with lithium.

The anode active material layer 220 includes some kind of anode active material among the anode active materials or a mixture of a plurality of different anode active materials. For example, the anode active material layer 220 may include only amorphous carbon, or may include at least one selected from the group consisting of gold (Au), platinum (Pt), palladium (Pd), silicon (Si), silver (Ag), aluminum (Al), bismuth (Bi), tin (Sn), and zinc (Zn). Unlike, the anode active material layer 22 may include only amorphous carbon, or may include a mixture of at least one selected from the group consisting of gold (Au), platinum (Pt), palladium (Pd), silicon (Si), silver (Ag), aluminum (Al), bismuth (Bi), tin (Sn), and zinc (Zn). The mixing ratio of the mixture of amorphous carbon and gold and the like is, for example, 10:1 to 1:2, 5:1 to 1:1, or 4:1 to 2:1, but is not necessarily limited to this range and is selected according to the required characteristics of the all-solid-state secondary battery 1. Since the anode active material has such a composition, the cycle characteristics of the all-solid-state secondary battery 1 may be further improved.

The anode active material included in the anode active material layer 220 may include a mixture of first particles made of amorphous carbon and second particles made of metal or metalloid. The metal or metalloid may include gold (Au), platinum (Pt), palladium (Pd), silicon (Si), silver (Ag), aluminum (Al), bismuth (Bi), tin (Sn), zinc (Zn), and the like. The metalloid may be semiconductors otherwise. The content of the second particles may be 8 to 60% by weight, 10 to 50% by weight, 15 to 40% by weight, or 20 to 30% by weight based on the total weight of the mixture. When the second particles have a content in this range, the cycle characteristics of the all-solid-state secondary battery 1 may be further improved.

In an embodiment, the anode active material layer 220 may further include a binder. For example, the binder is styrene-butadiene rubber (SBR), polytetrafluoroethylene, polyvinylidene fluoride, polyethylene, vinylidene fluoride/hexafluoropropylene copolymer, and polyacrylonitrile, polymethyl methacrylate, etc. are not necessarily limited thereto, and any binder used in the relevant technical field may be used. The binder may include a single binder or a plurality of different binders.

Since the anode active material layer 220 includes a binder, the anode active material layer 220 is stabilized on the anode current collector 210. In addition, cracks in the anode active material layer 220 are suppressed despite changes in volume and/or relative position of the anode active material layer 220 during the charging and discharging process. For example, when the anode active material layer 220 does not include a binder, the anode active material layer 220 may be easily separated from the anode current collector 210. As the anode active material layer 220 is separated from the anode current collector 210, the possibility that a short circuit occurs is increased when the anode current collector 210 contacts the solid electrolyte layer 300 in a part where the anode current collector 210 is exposed. The anode active material layer 220 is manufactured by applying a slurry in which the material constituting the anode active material layer 220 is dispersed onto the anode current collector 210 and drying the resultant anode current collector 210. The binder may be included in the anode active material layer 220 to stably disperse the anode active material in the slurry. For example, when the slurry is applied on the anode current collector 21 by screen printing, clogging of a screen (e.g., clogging by aggregates of anode active materials) may be suppressed.

In an embodiment, the anode active material layer 220 may further include an additive used in a conventional all-solid-state secondary battery, for example, a filler, a coating agent, a dispersant, an ion conductive auxiliary agent, and the like.

In an embodiment, the thickness of the anode active material layer 220 may be 50% or less, 40% or less, 30% or less, 20% or less, 10% or less, or 5% or less of the thickness of the cathode active material layer 120. The thickness of the anode active material layer 220 may be, for example, 1 μm to 20 μm, 2 μm to 10 μm, or 3 μm to 7 μm. When the thickness of the anode active material layer 220 is too small, lithium dendrites formed between the anode active material layer 220 and the anode current collector 210 collapse the anode active material layer 220, and thus it is difficult to improve cycle characteristics of the all-solid-state secondary battery 1. When the thickness of the anode active material layer 220 increases excessively, the energy density of the all-solid-state secondary battery 1 decreases and the internal resistance of the all-solid-state secondary battery 1 due to the anode active material layer 220 increases, thereby reducing the cycle characteristics of the all-solid-state secondary battery 1.

When the thickness of the anode active material layer 220 is decreased, the charging capacity of the anode active material layer 220 is also decreased. The charging capacity of the anode active material layer 220 may be, for example, 50% or less, 40% or less, 30% or less, 20% or less, 10% or less, 5% or less, or 2% or less of the charging capacity of the cathode active material layer 120. Alternatively, the charging capacity of the anode active material layer 220 is, for example, 0.1% to 50%, 0.1% to 40%, 0.1% to 30%, 0.1% to 20%, 0.1% to 10%, 0.1% to 5%, or 0.1% to 2%, of the charging capacity of the cathode active material layer 12.

The anode layer 200 may include the anode current collector 210 and the anode active material layer 220, and may further include a lithium metal layer deposited between the anode active material layer 220 and the anode current collector 210 during charging.

The solid electrolyte layer 300 is arranged between the cathode layer 100 and the anode layer 200, and may include a sulfide-based solid electrolyte.

The sulfide-based solid electrolyte includes, for example, at least one selected from Li₂S—P₂S₅, Li₂S—P₂S₅—LiX (X is an halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and Z is one of Ge, Zn and Ga), Li₂S—GeS₂, Li₂S—SiS₂—Li₃PO₄, Li₂S—SiS₂—LiₚMO_{q} (p and q are positive numbers, and M is one of P, Si, Ge, B, Al, Ga and In), Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). The sulfide-based solid electrolyte is manufactured by processing start raw materials such as LLS and P₂S₅ by a melt quenching method, a mechanical milling method, or the like. In addition, after such processing, heat treatment may be performed. The solid electrolyte may be amorphous, crystalline, or a mixture thereof. In addition, the solid electrolyte may include sulfur(S), phosphorus (P), and lithium (Li) as at least a component of the sulfide-based solid electrolyte material described above. For example, the solid electrolyte may be a material including Li₂S—P₂S₅. When using a material including Li₂S—P₂S₅ as a sulfide-based solid electrolyte material, to form the solid electrolyte, the mixed molar ratio of Li₂S and P₂S₅, that is, Li₂S:P₂S₅ is, for example, in a range of 50:50 to 90:10.

The sulfide-based solid electrolyte may be an argyrodite-type compound including one or more selected from Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be an argyrodite-type compound including one or more selected from the Li₆PS₅Cl, Li₆PS₅Br and Li₆PS₅I.

The density of the argyrodite-type solid electrolyte may be 1.5 g/cc to 2.0 g/cc. Since the argyrodite-type solid electrolyte has a density of 1.5 g/cc or more, the internal resistance of the all-solid-state secondary battery may be reduced, and penetration of the solid electrolyte by Li may be effectively suppressed. The modulus of elasticity of the solid electrolyte is, for example, 15 GPa to 35 GPa.

In an embodiment, the solid electrolyte layer 300 may include, for example, a binder. For example, the binder is styrene butadiene rubber (SBR), polytetrafluoroethylene, polyvinylidene fluoride, polyethylene, etc., and is not limited thereto and any binder used in the art may be used. The binder of the solid electrolyte layer 300 may be the same as or different from the binder included in each of the cathode active material layer 120 and the anode active material layer 220.

The elastic layer 400 is arranged at one side of the unit stack cell structure 30. For example, as shown in FIG. 1, the elastic layer 400 may be arranged between two unit cells 20. More specifically, the elastic layer 400 may be arranged on the unit cell 20 arranged at a lower portion of the housing 10, that is, on the anode layer 200. In addition, the elastic layer 400 may be arranged beneath the unit cell 20 arranged at an upper portion of the housing 10, that is, beneath the anode layer 200. Accordingly, the unit stack cell structure 30 may have a shape symmetrical with respect to the elastic layer 400. In particular, the elastic layer 400 is arranged to face the solid electrolyte layer 300 with the anode layer 200 therebetween, thereby preventing the elastic layer 400 from reacting with lithium and deteriorating. Through this, it is possible to increase the Coulombic efficiency of the all-solid-state secondary battery 1.

The elastic material forming the elastic layer 400 may include at least one selected from the group consisting of polyurethane, natural rubber, spandex, isobutylene isoprene rubber (IIR), fluoroelastomer, elastomer, ethylene-propylene rubber (EPR), styrene-butadiene rubber (SBR), chloroprene, elastin, rubber epichlorohydrin, nylon, terpene, isoprene rubber, polybutadiene rubber, nitrile rubber, thermoplastic elastomer, silicone rubber, ethylene-propylene-diene rubber (EPDM), ethylene vinyl acetate (EVA), halogenated butyl rubber, neoprene, and a copolymer thereof, and is not limited thereto. Any material with elasticity may be used without limitation. For example, the elastic material of the elastic layer 400 may include silicone rubber, cellulose fiber, polyolefin resin, polyurethane resin, acrylic resin, and the like. In an embodiment, the elastic layer 400 may include an acryl-based resin or a urethane-based resin.

In an embodiment, the elastic layer 400 may have a pad shape that is not foamed. For example, the elastic layer 400 may be placed in the unit stack cell structure 30 and inserted into the housing 10, and then maintained in an unfoamed state until the housing 10 is sealed and heated. Accordingly, the volume of the elastic layer 400 is relatively smaller than the volume after foaming, and thus, the unit stack cell structure 30 may be easily inserted into the housing 10 without pressing the unit stack cell structure 30. In addition, when the unit stack cell structure 30 is completely inserted into the housing 10, the elastic layer 400 may be foamed. After foaming, the elastic layer 400 may have a foamed shape.

In an embodiment, the elastic layer 400 may have a thickness of 100 μm to 800 μm before foaming, and the thickness after foaming may be 1.1 to 2 times the thickness before foaming.

In an embodiment, the elastic layer 400 may have adhesive properties. For example, a material with an adhesive component is applied to at least a portion of the elastic layer 400, more specifically, to the top and bottom surfaces of the elastic layer 400, and thus, the elastic layer 400 may be firmly fixed to the anode layers 200.

A method of preparing the elastic layer 400 is not particularly limited. In an embodiment, a syrup is prepared through a mass polymerization method of acrylate monomers including hydroxy groups and acrylate monomers including alkyl groups by using heat or UV. The prepared syrup is mixed with acrylic monomers, silica, 2 to 6 functional acrylate, foaming agents or hollow microspheres, and photoinitiators or thermal initiators, and the mixed mixture is applied onto a polyethylene terephthalate (PET) release film so as to be cured with UV, thereby preparing the elastic layer 400.

In an embodiment, the elastic layer 400 may further include reinforcing particles. For example, the elastic layer 400 may include hollow particles as reinforcing particles. The hollow particles are uniformly or non-uniformly distributed in the elastic layer 400 to increase a compressive strength of the elastic layer 400 and at the same time increase a restoring force thereof.

More specifically, in the all-solid-state secondary battery 1, when the unit stack cell structures 30 are laminated and sealed, the compressive strength of the elastic layer 400 is important. However, if the compressive strength is too high, it is difficult to lower the density, and implement stress relief characteristics, and charging/discharging efficiency is degraded due to high stress during compression and restoring. On the contrary, if the compressive strength is too low, the compression rate of the elastic layer 400 increases during sealing and becomes densified, making it difficult to implement compression and restoring characteristics during charging and discharging. In particular, compressive strength and stress relief are opposite properties and it is difficult to achieve both at the same time.

Accordingly, in the all-solid-state secondary battery 1 according to an embodiment of the present disclosure, the compressive strength is increased by including hollow particles in the elastic layer 400. In an embodiment, the elastic layer 400 may include an elastic material including at least one of nanoparticles, nanosilica, nano hollow particles, and micro hollow particles, each having a core-shell structure.

In an embodiment, the compressive strength of the elastic layer 400 may be 0.20 MPa to 0.5 MPa. The elastic layer 400 may preferably have a compressive strength of 0.25 MPa to 0.4 MPa. More preferably, the elastic layer 400 may have a compressive strength of 0.28 MPa to 0.32 MPa. When the compressive strength of the elastic layer 400 is lower than 0.28 MPa, the layers of the all-solid-state secondary battery 1 may not maintain sufficient contact pressure with each other. In addition, if the compressive strength of the elastic layer 400 is higher than 0.32 MPa, cracks may be caused in the solid electrolyte layer 300 after foaming the elastic layer 400.

In an embodiment, the elastic layer 400 may include elastic particles as reinforcing particles. The elastic particles may increase stress relief characteristics of the elastic layer 400.

More specifically, in the case of the elastic layer 400 made of an acrylic material, the restoring force may be relatively low. In the elastic layer 400, a stress relief and a restoring force are characteristics that oppose each other, and the restoring force may be increased by increasing the amount of crosslinking agent, but in this case, stress relief characteristics are reduced. To this end, the all-solid-state secondary battery 1 according to an embodiment of the present disclosure includes elastic particles in the elastic layer 400, thereby increasing the restoring force while maintaining the stress relief characteristics. For example, the elastic particles may be particles with a diameter of 1,000 nm or less.

In an embodiment, the restoring ratio of the elastic layer 400 may be 70% or more and less than 100%. Preferably, the restoring ratio of the elastic layer 400 may be 80% to 99%. More preferably, the restoring ratio of the elastic layer 400 may be 85% to 98%. When the restoring ratio of the elastic layer 400 is less than 85%, a sufficient restoring force may not be obtained in the required compressive strength range, and thus the discharging efficiency and life of the all-solid-state secondary battery 1 may be reduced. When the restoring ratio of the elastic layer 400 exceeds 98%, stress relief characteristics during charging may be lowered, and thus charging efficiency may be reduced.

In an embodiment, a foam ratio of the elastic layer 400 may be 110% to 250%. Preferably, the foam ratio of the elastic layer 400 may be 120% to 230%. More preferably, the foam ratio of the elastic layer 400 may be 140% to 210%. When the foam ratio of the elastic layer 400 is less than 140%, it is difficult for the elastic layer 400 to provide a sufficient buffering function. When the foam ratio of the elastic layer 400 is greater than 210%, the elastic layer 400 may be excessively thick after foaming, and thus may be non-uniformly formed, or a difference in density may be large and thus, may be non-uniformly formed to cause cracks in the solid electrolyte.

In an embodiment, the foam forming the elastic layer 400 may have a density of 0.7 g/cm² or less. If the density of the foam is higher than this, the compressive strength may be excessively high. In addition, if the density of the foam is too low, the restoring force may be reduced by connecting the pores of the foam with the walls of the backbone during subsequent charging and discharging.

In an embodiment, the elastic layer 400 may be foamed after being inserted into the housing 10. For example, the elastic layer 400 maintains a unfoamed pad state, which may then be inserted into the housing 10 and then heated to be foamed. As the elastic layer 400 expands after foaming, the unit stack cell structure 30 may be compressed into the housing 10. For example, the elastic layer 400 may be heated to a temperature of 120° C. to 140° C. to be foamed. The method of heating the elastic layer 400 is not particularly limited. For example, the all-solid-state secondary battery 1 may be housed in a convection oven or the like and heated as one unit.

Through such a configuration, the all-solid-state secondary battery 1 according to an embodiment of the present disclosure may obtain a unit stack cell structure 30 with excellent stress relief characteristics, restoring force, and compressive strength. In particular, the all-solid-state secondary battery 1 according to an embodiment of the present disclosure is inserted into the housing 10 while maintaining the elastic layer 400 included in the unit stack cell structure 30 in an unfoamed state and then foamed, and thus, the unit stack cell structure 30 including the elastic layer 400 with excellent restoring characteristics may also be easily inserted into the housing 10.

In another embodiment, as shown in FIG. 2, the all-solid-state secondary battery 1 may include a unit stack cell structure 30A. When comparing the unit stack cell structure 30A with the unit stack cell structure 30 according to the embodiment described above, the arrangement of unit cells 20A and an elastic layer 400A is different from the arrangement of unit cells 20 and the elastic layer 400, and the remaining configuration of the unit stack cell structure 30A may be the same as that of the unit stack cell structure 30. Hereinafter, for convenience of explanation, different configurations will be mainly described.

For example, the unit stack cell structure 30A may contain two unit cells 20A and an elastic layer 400A placed between the unit cells 20A. Each of the unit cells 20A includes a cathode layer 100A, an anode layer 200A, and a solid electrolyte layer 300A, and the configuration of each of the unit cells 20A may be the same as that of each of the unit cells 20 described above.

In each of the unit cells 20A of the unit stack cell structure 30A, a cathode layer 100A, a solid electrolyte layer 300A, and an anode layer 200A are sequentially laminated, and an elastic layer 400A is arranged on the anode layer 200A. In addition, another unit cell 20A is placed again on top of the elastic layer 400A, and another elastic layer 400A is placed again on top of the unit cell 20A. Compared to manufacturing of the stack cell, it is easy to manufacture the unit cell and is advantageous during lamination due to low defect rate, but the thickness increases and the cell capacity per unit volume decreases due to the use of the cross sections of both the cathode and anode. In addition, the stability of the all-solid-state secondary battery 1 may be increased by arranging the anode layer 200A relatively on an outer periphery.

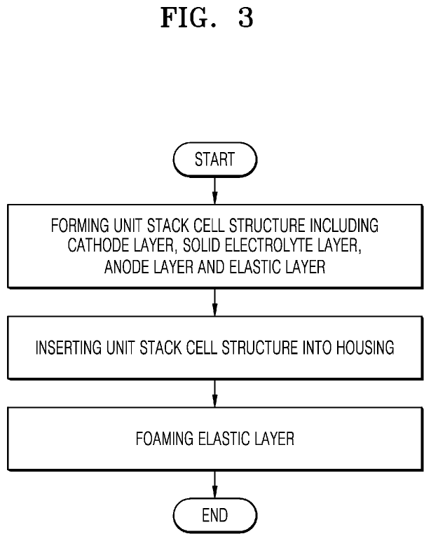

Hereinbelow, referring to FIGS. 3 to 6, a method of manufacturing an all-solid-state secondary battery 1 according to an embodiment of the present disclosure is described.

A method of manufacturing an all-solid-state secondary battery 1 according to an embodiment of the present disclosure may include forming a unit stack cell structure 30, inserting the unit stack cell structure 30 into a housing 10, and foaming an elastic layer 400.

First, a cathode layer 100, an anode layer 200, a solid electrolyte layer 300, and an elastic layer 400 forming the unit stack cell structure 30 are manufactured. The cathode layer 100 may include a cathode current collector 110 and a cathode active material layer 120, and the anode layer 200 may include an anode current collector 210 and an anode active material layer 220. In addition, as described above, the cathode layer 100 and the anode layer 200 may include an electrolyte, a binder, and other additional materials.

In order to prepare the elastic layer 400, a syrup is prepared through a mass polymerization method of acrylate monomers including hydroxy groups and acrylate monomers including alkyl groups by using heat or UV. In addition, the prepared syrup is mixed with acrylic monomers, silica, 2 to 6 functional acrylate, foaming agents or hollow microspheres, photoinitiators or thermal initiators, hollow particles, and/or elastic particles, and the mixed mixture is applied onto a polyethylene terephthalate (PET) release film so as to be cured with UV, thereby preparing the elastic layer 400.

Next, the cathode layer 100, the anode layer 200, the solid electrolyte layer 300, and the elastic layer 400, which have been prepared as described above, are laminated. For example, a unit cell 20 is formed by sequentially stacking the solid electrolyte layer 300 and the anode layer 200 on the cathode layer 100. Next, an elastic layer 400 is placed on the anode layer 200, and an anode layer 200, a solid electrolyte layer 300, and a cathode layer 100 are sequentially laminated above the elastic layer 400 so that two unit cells 20 are symmetrical to each other with the elastic layer 400 therebetween, to thereby form a unit stack cell structure 30.

In another embodiment, a cathode layer 100A, a solid electrolyte layer 300A, and an anode layer 200A are sequentially laminated to form a unit cell 20A, and an elastic layer 400A is arranged on the anode layer 200A. Then, after another unit cell 20A is placed on the elastic layer 400A, another elastic layer 400A may be placed on the unit cell 20A again to form a unit stack cell structure 30A. Hereinafter, a method of manufacturing the unit stack cell structure 30 will be mainly described for convenience of description, but the same manufacturing method may be applied to the unit stack cell structure 30A except for a stacking order and method.

In an embodiment, in the forming of the unit stack cell structure 30, the elastic layer 400 may be in an unfoamed state. That is, the prepared elastic layer 400 may maintain the shape of an unfoamed pad in a state included in the unit stack cell structure 30.

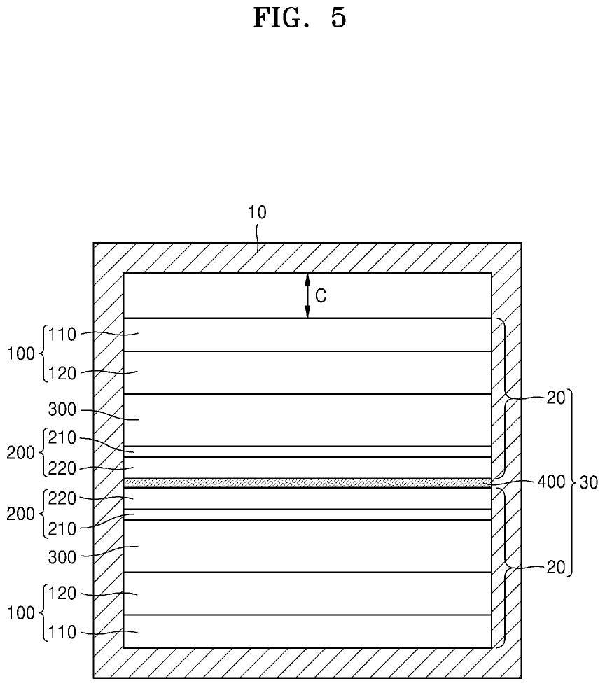

Next, the unit stack cell structure 30 is inserted into the housing 10. Here, no force is applied to the unit stack cell structure 30, and the unit stack cell structure 30 may not be in a state of being compressed or stretched. For example, as shown in FIG. 5, the unit stack cell structure 30 may form a gap C with an inner top surface of the housing 10 in a state where the unit stack cell structure 30 has been inserted into the housing 10. This is because the elastic layer 400 included in the unit stack cell structure 30 has not been yet foamed. By using the unfoamed elastic layer 400 in this way, the unit stack cell structure 30 may be easily inserted into the housing 10.

Then, the housing 10 is sealed. For example, after inserting the unit stack cell structure 30 through one open surface of the housing 10, the open surface may be sealed by welding, staking, brazing, bolting, etc.

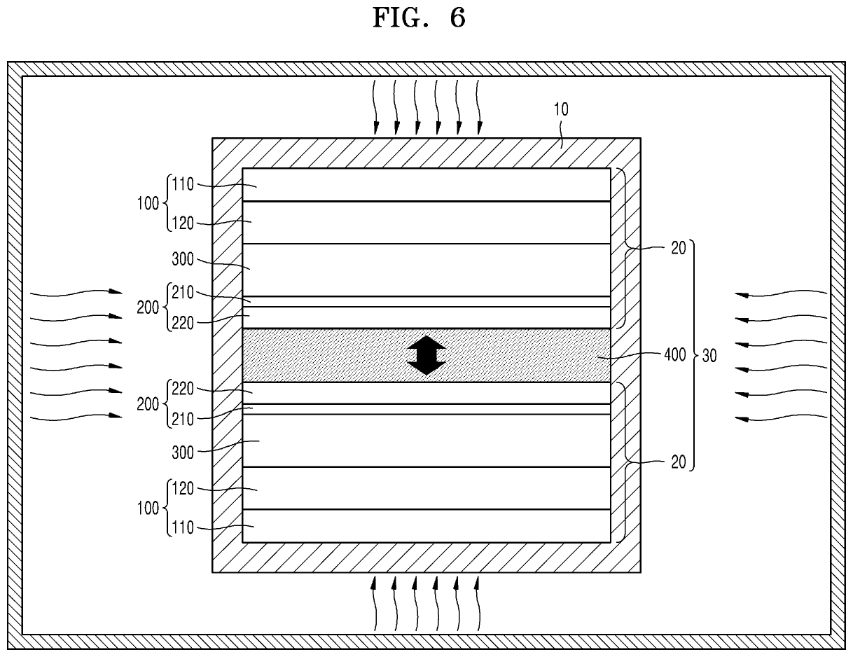

Then, the housing 10 is heated to foam the elastic layer 400. For example, the housing 10 into which the unit stack cell structure 30 is inserted is placed in a convection oven, etc., and then heated at 120° C. to 140° C. to foam the elastic layer 400. Accordingly, the elastic layer 400 may be foamed in the housing 10 to have a foam shape. In addition, as shown in FIG. 6, as a thickness of the elastic layer 400 increases, an upper part of the unit stack cell structure 30 comes into contact with an inner upper surface of the housing 10.

In one embodiment, the thickness of the foamed elastic layer 400 may be 1.1 times to 2 times a thickness of the elastic layer 400 before foaming, that is, 100 μm to 800 μm.

### [Preparation of Resin]

In order to prepare an elastic layer, first, a solvent-free acrylate mixed resin having a weight average molecular weight of 1.2 million was prepared. A solvent-free acrylate mixed resin with a weight average molecular weight of 1.2 million was prepared by mixing 4-hydroxybutyl acrylate (4-HBA) (Osaka Organic Chemical) with 2-EHA (LG Chemical) at a weight ratio of 30/70, adding 0.01 parts by weight of photoinitiator (Irgacure 651) and irradiating UV rays thereon.

### Example 1

Based on 100 parts by weight of the solvent-free acrylate mixed resin, 0.5 parts by weight of the photoinitiator (Irgacure 651), 0.3 parts by weight of a crosslinking agent (1,6-hexanediol diacrylate (HDDA), Sigma Aldrich), and 6 parts per hundred resin (phr) of a foaming agent were mixed with the solvent-free acrylate mixed resin, and the resultant mixture was applied between silicon release-treated general-purpose polyethylene terephthalate (PET) films to produce an 80 μm pad by irradiating UV as much as 2000 mj/cm². After foaming the 80 μm pad at 140° C., the thickness of the 80 μm pad was changed to 140 μm.

### Example 2

An 80 μm pad was prepared as an elastic layer by UV curing after injection of 6 phr of polymer microspheres except for the foaming agent in Example 1. After foaming the 80 μm pad at 140° C., the thickness of the 80 μm pad was changed to 140 μm.

### Example 3

An 80 μm pad was prepared as an elastic layer by UV curing after injection of 8 phr of polymer microspheres except for the foaming agent in Example 1. After foaming the 80 μm pad at 140° C., the thickness of the 80 μm pad was changed to 140 μm.

### Example 4

An 80 μm pad was prepared as an elastic layer by UV curing after injection of 5 phr of polymer microspheres except for the foaming agent in Example 1. After foaming the 80 μm pad at 140° C., the thickness of the 80 μm pad was changed to 130 μm.

### Example 5

An 80 μm pad was prepared as an elastic layer by UV curing after injection of 8 phr of polymer microspheres except for the foaming agent in Example 1. After foaming the 80 μm pad at 165° C., the thickness of the 80 μm pad was changed to 165 μm.

### Comparative Example 1

An acrylic elastic sheet (Youngwoo, BHF) of 125 μm was applied.

### Comparative Example 2

A pad with a thickness of 80 μm was prepared without including polymer microspheres for foaming in Example 2.

### Comparative Example 3

An 80 μm pad was prepared as an elastic layer by UV curing after injection of 3 phr of polymer microspheres in Comparative Example 2. After foaming the 80 μm pad at 140° C., the thickness of the 80 μm pad was changed to 100 μm.

### Comparative Example 4

An 80 μm pad was prepared as an elastic layer by UV curing after injection of 6 phr of polymer microspheres in Comparative Example 2. After foaming the 80 μm pad at 110° C., the thickness of the 80 μm pad was changed to 120 μm.

### Comparative Example 5

An 80 μm pad was prepared as an elastic layer by UV curing after injection of 8 phr of polymer microspheres in Comparative Example 2. After foaming the 80 μm pad at 110° C., the thickness of the 80 μm pad was changed to 130 μm.

### Comparative Example 6

An 80 μm pad was prepared as an elastic layer by UV curing after injection of 8 phr of polymer microspheres in Comparative Example 2. After foaming the 80 μm pad at 180° C., the thickness of the 80 μm pad was changed to 150 μm.

### Comparative Example 7

An 80 μm pad was prepared as an elastic layer by UV curing after injection of 8 phr of a foaming agent (JTR) without injecting polymer microspheres in Comparative Example 2. After foaming the 80 μm pad at 140° C., the thickness of the 80 μm pad was changed to 165 μm.

### Comparative Example 8

An 80 μm pad was prepared as an elastic layer by UV curing after injection of 10 phr of a foaming agent (JTR) without injecting polymer microspheres in Comparative Example 2. After foaming the 80 μm pad at 150° C., the thickness of the 80 μm pad was changed to 180 μm.

### Comparative Example 9

An 80 μm pad was prepared as an elastic layer by UV curing after injection of 4 phr of a foaming agent (JTR) without injecting polymer microspheres in Comparative Example 2. After foaming the 80 μm pad at 140° C., the thickness of the 80 μm pad was changed to 120 μm.

### Evaluation Example 1: Measurement of Physical Properties of Elastic Layer

The physical properties of the elastic layers included in Examples 1 to 5 and Comparative Examples 1 to 9 were measured as follows, and the results are shown in Table 1 below.

### (1) Compressive Strength

The compressive strength was obtained by compressing a foamed elastic layer to 70% of an original thickness at a rate of 10 μm/sec using a jig, and then dividing a load at a point of 40% of the compressive strength by an area of a test piece.

### (2) Restoring Ratio

The restoring ratio was obtained as a ratio of a force at the point of 40% of the compressive strength when the foamed elastic layer was compressed to 70% of the original thickness using a jig at a speed of 10 μm/sec and then immediately returned at the speed of 10 μm/sec., and the following Equation 1 was used.

$$Restoring ratio ( \% ) = ( Stress at restoring at displacement of 40 \% of thickness \text{)/(} Stress at compression at displacement of 40 \% of thickness ) \times 100 \qquad 〈 Equation 1 〉$$

### (3) Foaming Ratio

The foaming ratio was calculated by dividing a thickness of the elastic layer after foaming by an initial thickness of the elastic layer before foaming.

TABLE 1

| | | | | | | COMPAR- | COMPAR- | COMPAR- |
|---|---|---|---|---|---|---|---|---|
| | | | | | | ATIVE | ATIVE | ATIVE |
| | EXAMPLE 1 | EXAMPLE 2 | EXAMPLE 3 | EXAMPLE 4 | EXAMPLE 5 | EXAMPLE 1 | EXAMPLE 2 | EXAMPLE 3 |
| COM- | 0.28 | 0.289 | 0.287 | 0.298 | 0.285 | 0.275 | 0.342 | 0.32 |
| PRESSIVE | | | | | | | | |
| STRENGTH | | | | | | | | |
| (MPa) | | | | | | | | |
| RESTORING | 86.5 | 83.5 | 93.1 | 95.7 | 91.5 | 91.1 | 95 | 89.1 |
| RATIO (%) | | | | | | | | |
| FOAMING | 1.8 | 1.8 | 2.0 | 1.6 | 2.1 | — | 1.0 | 1.3 |
| RATIO | | | | | | | | |

| | COMPAR- | COMPAR- | COMPAR- | COMPAR- | COMPAR- | COMPAR- |
|---|---|---|---|---|---|---|
| | ATIVE | ATIVE | ATIVE | ATIVE | ATIVE | ATIVE |
| | EXAMPLE 4 | EXAMPLE 5 | EXAMPLE 6 | EXAMPLE 7 | EXAMPLE 8 | EXAMPLE 9 |
| COM- | 0.321 | 0.335 | 0.275 | 0.162 | 0.132 | 0.34 |
| PRESSIVE | | | | | | |
| STRENGTH | | | | | | |
| (MPa) | | | | | | |
| RESTORING | 93 | 95.7 | 82.5 | 85.4 | 74.8 | 91.5 |
| RATIO (%) | | | | | | |
| FOAMING | 1.5 | 1.6 | 1.9 | 2.1 | 2.3 | 1.5 |
| RATIO | | | | | | |

As shown in Table 1, all of Examples 1 to 5 satisfy a compressive strength of 0.28 MPa to 0.32 MPa, a restoring ratio of 85% to 98%, and a foaming ratio of 140% to 210%.

On the contrary, in Comparative Examples 1 to 9, at least one of a compressive strength, a restoring ratio, and a foaming ratio has not satisfied the ranges specified in the present disclosure.

Through physical property measurements, the all-solid-state secondary batteries of Examples 1 to 5 have more excellent compressive strength, exhibit more sufficient restoring force and more excellent discharging efficiency, and provide more sufficient cushioning functions and more uniform moldability, compared to Comparative Examples 1 to 9.

### Evaluation Example 2: Surface Conditions

Surface conditions of all-solid-state secondary batteries prepared in Examples 1 to 5 and Comparative Examples 1 to 9 were evaluated, and the results are shown in Table 2 below. The surface conditions were evaluated by visually observing the surfaces of the all-solid-state secondary batteries after foaming. If there were protrusions due to foaming on the surfaces or if the surfaces were uneven, the surface conditions were evaluated as bad.

Examples 1 to 5 had uniform surfaces after foaming.

In Comparative Examples 1 to 6 and 9, the surfaces were uniform after foaming.

Comparative Examples 7 and 8 had uneven surfaces such as protrusions formed on the surfaces after foaming.

Through confirmation of the surface conditions, it was found that the all-solid-state secondary batteries of Examples 1 to 5 maintained uniform surface conditions without forming protrusions even after foaming. Accordingly, the all-solid-state secondary batteries of Examples 1 to 5 may achieve high discharging efficiency and prevent cracks in the solid electrolyte by maintaining uniform surface pressure throughout the unit stack cell structure.

As described above, embodiments have been described with reference to the drawings and the examples, but this is only examples, and a person skilled in the art will understand that various modifications and equivalent other embodiments are possible therefrom. Therefore, the scope of protection of the present disclosure should be determined by the appended claims.

### INDUSTRIAL APPLICABILITY

The present disclosure may be used in industries related to secondary batteries.

1. A method of manufacturing an all-solid-state secondary battery, the method comprising:
forming a unit stack cell structure including a cathode layer, a solid electrolyte layer, an anode layer, and an elastic layer;
inserting the unit stack cell structure into a housing; and
foaming the elastic layer, wherein,
in the forming of the unit stack cell structure, the elastic layer has a pad shape that is not foamed, and
in the foaming of the elastic layer, the elastic layer is in the form of a foam.

2. The method of claim 1, further comprising, before the forming of the unit stack cell structure, forming the elastic layer, wherein, in the forming of the elastic layer, a foaming agent and reinforcing particles are mixed with a syrup including an acrylate monomer.

3. The method of claim 1, wherein the forming of the elastic layer comprises:
preparing a syrup by bulk polymerization of acrylate monomers including hydroxy groups as acrylate monomers and acrylate monomers including alkyl groups by using heat or ultraviolet (UV);
mixing the syrup with acrylic monomers, silica, 2 to 6 functional acrylate, foaming agents, photoinitiators or thermal initiators, and the reinforcing particles to prepare a mixture; and
coating a polyethylene terephthalate (PET) release film with the mixture, followed by curing the same with UV.

4. The method of claim 2, wherein the reinforcing particles comprise an elastic material and comprise elastic particles with a diameter of 1,000 nm or less.

5. The method of claim 4, wherein the elastic material comprises at least one selected from the group consisting of polyurethane, natural rubber, spandex, isobutylene isoprene rubber (IIR), fluoroelastomer, elastomer, ethylene-propylene rubber (EPR), styrene-butadiene rubber (SBR), chloroprene, elastin, rubber epichlorohydrin, nylon, terpene, isoprene rubber, polybutadiene rubber, nitrile rubber, thermoplastic elastomer, silicone rubber, ethylene-propylene-diene monomer (EPDM) rubber, ethylene vinyl acetate (EVA), halogenated butyl rubber, neoprene, and a copolymer thereof.

6. The method of claim 3, wherein the reinforcing particles comprise hollow particles including at least one of nanoparticles having a core-shell structure, nanosilica, hollow nanoparticles, and hollow microparticles.

7. The method of claim 1, wherein the foaming of the elastic layer comprises heating the elastic layer at 120° C. to 140° C.

8. The method of claim 7, wherein the elastic layer has a thickness of 100 μm to 800 μm before foaming, and the thickness after foaming is 1.1 to 2 times the thickness before foaming.

9. The method of claim 1, wherein the forming of the unit stack cell structure comprises sequentially laminating the anode layer, the solid electrolyte layer, and the cathode layer in that order on each of one side and the other side of the elastic layer, so as to face each other around the elastic layer.

10. The method of claim 1, wherein the forming of the unit stack cell structure is performed by repeatedly stacking the cathode layer, the solid electrolyte layer, the anode layer, and the elastic layer in that order.

11. An all-solid-state secondary battery comprising:
a housing; and a unit stack cell structure arranged in the housing and including a cathode layer, a solid electrolyte layer, an anode layer, and an elastic layer, wherein the elastic layer is in the form of a pad that is not foamed, and is foamed after being inserted into the housing to have a foam shape.

12. The all-solid-state secondary battery of claim 11, wherein the elastic layer comprises an elastic material and comprises elastic particles with a diameter of 1,000 nm or less.

13. The all-solid-state secondary battery of claim 12, wherein the elastic material comprises at least one selected from the group consisting of polyurethane, natural rubber, spandex, isobutylene isoprene rubber (IIR), fluoroelastomer, elastomer, ethylene-propylene rubber (EPR), styrene-butadiene rubber (SBR), chloroprene, elastin, rubber epichlorohydrin, nylon, terpene, isoprene rubber, polybutadiene rubber, nitrile rubber, thermoplastic elastomer, silicone rubber, ethylene-propylene-diene monomer (EPDM) rubber, ethylene vinyl acetate (EVA), halogenated butyl rubber, neoprene, and a copolymer thereof.

14. The all-solid-state secondary battery of claim 11, wherein the elastic layer comprises hollow particles including at least one of nanoparticles having a core-shell structure, nanosilica, hollow nanoparticles, and hollow microparticles.

15. The all-solid-state secondary battery of claim 11, wherein the elastic layer has a thickness of 100 μm to 800 μm before foaming, and the thickness after foaming is 1.1 to 2 times the thickness before foaming.

16. The all-solid-state secondary battery of claim 11, wherein the unit stack cell structure is formed by sequentially laminating the anode layer, the solid electrolyte layer, and the cathode layer in that order on each of one side and the other side of the elastic layer, so as to face each other around the elastic layer.

17. The all-solid-state secondary battery of claim 11, wherein the unit stack cell structure is formed by repeatedly laminating the cathode layer, the solid electrolyte layer, the anode layer, and the elastic layer in that order.
